(19) United States
(12) Patent Application Publication
(10) Pub. No.: US 2015/0302591 A1
(43) Pub. Date: Oct. 22, 2015

(54) SYSTEM FOR DETECTING OBSTACLE USING ROAD SURFACE MODEL SETTING AND METHOD THEREOF

(71) Applicant: Hyundai Motor Company, Seoul (KR)

(72) Inventors: Jae Kwang KIM, Seoul (KR); Yoon Ho JANG, Seoul (KR)

(21) Appl. No.: 14/465,529

(22) Filed: Aug. 21, 2014

(30) Foreign Application Priority Data
Apr. 16, 2014 (KR) 10-2014-0045537

(51) Int. Cl. G06T 7/00; B60R 1/00

(52) U.S. Cl. CPC G06T 7/0046; B60R 1/002; G06T 2207/10016; G06T 2207/30261; G06T 2207/20021; B60R 2300/8093

(57) ABSTRACT

A system for detecting an obstacle includes an image acquisitor configured to acquire image data around a camera. An obstacle detector is configured to apply a road surface model using a horizon or a vanishing point to the image data and perform a sliding window on a road surface region to detect the obstacle.

### CROSS-REFERENCE TO RELATED APPLICATION

This application is based on and claims the benefit of priority to Korean Patent Application No. 10-2014-0045537, filed on Apr. 16, 2014 in the Korean Intellectual Property Office, the disclosure of which is incorporated herein in its entirety by reference.

### TECHNICAL FIELD

The present disclosure relates to a system for detecting an obstacle using road surface model setting and a method thereof, and more particularly, to a technology of detecting an obstacle by applying a road surface model to image data.

### BACKGROUND

Recently, a system for photographing and monitoring surrounding environment of a vehicle has been gradually developed. With the development of an image processing technology, images around the vehicle can be simply displayed, and objects from the images around the vehicle can be detected to determine whether the vehicle is likely to collide with the objects, and thus informing the driver a possibility of collision has been also developed.

The related art above simply provides the images acquired by photographing front and back portions of the vehicle without viewpoint transformation. A technology of transforming the images around the vehicle into a virtual viewpoint, so-called, a top view viewpoint which looks down at the ground from the top of the vehicle to more clearly show the driver whether the vehicle contacts the objects around the vehicle at the time of parking, and the like has been also developed.

However, the technology of transforming the images around the vehicle is slow in speed and frequently causes detection errors due to unnecessary information such as a background region.

### SUMMARY

The present disclosure has been made to solve the above-mentioned problems occurring in the prior art while advantages achieved by the prior art are maintained intact.

An aspect of the present disclosure performs a sliding window on only a road surface region by applying a road surface model without detecting unnecessary information to accurately and rapidly detect an obstacle and to provide the detected obstacle to a driver, thereby supporting safe driving of the driver.

According to an exemplary embodiment of the present disclosure, a system for detecting an obstacle includes an image acquisition unit configured to acquire image data around a camera. An obstacle detector is configured to apply a road surface model using a horizon or a vanishing point to the image data and performs a sliding window on a road surface region to detect the obstacle.

The system may further include a display configured to display the obstacle on the image data along with distance information.

The obstacle detector may include a storage configured to store the image data. A data analyzer is configured to detect the horizon or the vanishing point in the image data. A road surface model applying unit is configured to use the horizon or the vanishing point in the image data to set and applies the road surface model. An obstacle tracker is configured to perform the sliding window on the road surface region of the image data to which the road surface model is applied to track the obstacle.

The road surface model applying unit may transform an actual distance coordinate into an image coordinate of the image data and set the road surface model to which the horizon or vanishing point coordinate is applied.

The road surface model applying unit may set the road surface model, so that in the image data, a vertical coordinate of the obstacle within a short range is suddenly increased, and a vertical coordinate of the obstacle within a long range is smoothly increased.

The road surface model applying unit may apply the road surface model to the image data and calculate distance information from a vehicle of the road surface region. The obstacle tracker may perform scanning on each pixel of the image data, acquire distance information of the pixel to determine window sizes for each distance, and perform the sliding window to detect the obstacle.

According to another exemplary embodiment of the present disclosure, a method for detecting an obstacle includes acquiring image data outside a vehicle while the vehicle is driven. A road surface model is designed and applied from the image data. A sliding window is performed on a road surface below a horizon or a vanishing point in the image data to which the road surface model is applied to detect the obstacle.

The method may further include displaying the obstacle on the image data and displaying distance information between the vehicle and the obstacle in the image data.

In the step of displaying the distance information between the obstacle and the own vehicle, the distance information on each obstacle may be represented by a number.

The step of designing and applying the road surface model may include calculating a horizon or vanishing point coordinate from the image data. The road surface model is designed for the image data. The calculated horizon or vanishing point coordinate is applied to the designed road surface model to define the road surface model. A distance of a road surface region is calculated using the road surface model.

In the step of designing the road surface model, an actual distance coordinate may be transformed into an image coordinate of the image data and the road surface model to which the horizon or vanishing point coordinate is applied may be set.

The road surface model may have characteristics in the image data, such that a vertical coordinate of the obstacle within a short range is suddenly increased and a vertical coordinate of the obstacle within a long range is smoothly increased.

The step of performing the sliding window may include scanning pixels within the image data to which the road surface model is applied. Distance information on the scanned pixels is acquired. Window sizes for each distance are determined. The determined window is applied to perform the sliding window.

In the step of determining the window sizes for each distance, the window size may be determined as the number of pixels.

### BRIEF DESCRIPTION OF T DRAWINGS

The above and other objects, features and advantages of the present disclosure will be more apparent from the following detailed description taken in conjunction with the accompanying drawings.

FIG. 1 is a configuration diagram of a system for detecting an obstacle according to an exemplary embodiment of the present disclosure.

FIG. 2 is a diagram illustrating a method for detecting an obstacle according to an exemplary embodiment of the present disclosure.

FIGS. 3A and 3B are diagrams for describing a method for detecting a horizon in image data according to an exemplary embodiment of the present disclosure.

FIGS. 4A to 4D are diagrams for describing a method for detecting a vanishing point in the image data according to an exemplary embodiment of the present disclosure.

FIG. 5 is a graph for describing a method for designing a road surface model according to an exemplary embodiment of the present disclosure.

FIG. 6A is a graph illustrating a vertical direction position in the image data depending on the road surface model according to the exemplary embodiment of the present disclosure.

FIG. 6B is a diagram illustrating results acquired by actually photographing the vertical direction position with a camera in the image data depending on the road surface model according to the exemplary embodiment of the present disclosure.

FIG. 7A is a diagram illustrating an actual horizon coordinate B′ calculated from the image data acquired according to the exemplary embodiment of the present disclosure and an ideal horizon coordinate B.

FIG. 7B is a diagram illustrating an actual vanishing point coordinate B′ calculated from the image data acquired according to the exemplary embodiment of the present disclosure and an ideal vanishing point coordinate B.

FIG. 8A is an exemplified diagram of the image data acquired according to the exemplary embodiment of the present disclosure.

FIG. 8B is an exemplified diagram of distance information acquired by applying a road surface model to the image data according to the exemplary embodiment of the present disclosure.

FIG. 8C is an exemplified diagram of a detection of an obstacle by setting a window in the image data according to the exemplary embodiment of the present disclosure.

FIG. 8D is an exemplified diagram of the obstacle detected in the image data according to the exemplary embodiment of the present disclosure.

FIGS. 9A to 9C are diagrams for describing a method for detecting an obstacle depending on a sliding window according to an exemplary embodiment of the present disclosure.

FIGS. 10A to 10D are exemplified diagrams of displaying the obstacle detected by the method for detecting an obstacle according to the exemplary embodiment of the present disclosure on the image data depending on the distance information.

### DETAILED DESCRIPTION

Hereinafter, embodiments of the present disclosure will be described in detail with reference to the accompanying drawings so that those skilled in the art may easily practice the present disclosure.

The present disclosure discloses a method for setting a road surface model which may be applied to a method for detecting an obstacle using a monocular camera. To this end, the present disclosure discloses a technology of acquiring image data from a camera provided in a vehicle, applying a road surface model to the acquired image data, detecting the obstacle by performing a sliding window, and dividing and displaying the detected obstacle depending on a distance.

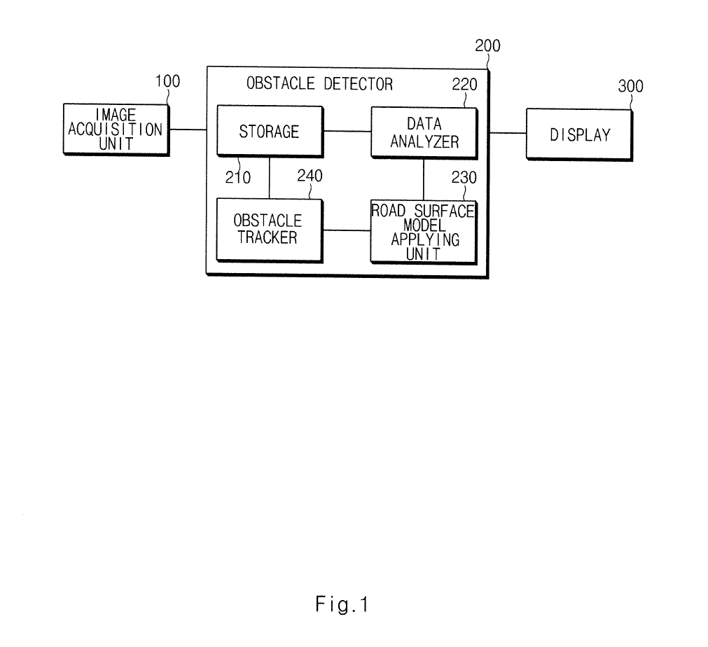

Hereinafter, embodiments of the present disclosure will be described in detail with reference to FIGS. 1 to 10D.

FIG. 1 is a configuration diagram of a system for detecting an obstacle according to an exemplary embodiment of the present disclosure.

The system for detecting an obstacle according to an exemplary embodiment of the present disclosure includes an image acquisition unit 100, an obstacle detector 200, and a display 300.

The image acquisition unit 100 may acquire images around a vehicle, such as front, back, and sides of the vehicle. According to an exemplary embodiment of the present disclosure, in particular, image data in front of the vehicle is used to detect an obstacle in front of the vehicle. The image acquisition unit 100 may be implemented as a camera, an image sensor, and the like.

The obstacle detector 200 designs a road surface model which may confirm distance information, excludes a background screen above a horizon or a vanishing point, and detects the obstacle on a road surface region under the horizon or the vanishing point using a sliding window method.

To this end, the obstacle detector 200 includes a storage 210, a data analyzer 220, a road surface model applying unit 230, and an obstacle tracker 240.

The data analyzer 220, the road surface model applying unit 230, and the obstacle tracker 240 may be implemented with a processor and a computer-readable medium having instructions, execution of which causes the processor to perform the functions of the data analyzer 220, the road surface model applying unit 230, and the obstacle tracker 240 as described below.

The computer readable medium include a non-transitory computer-readable medium, such as a memory, which may be any physical device used to store programs or data on a temporary or permanent basis for use by the processor.

The storage 210 stores image data received from the image acquisition unit 100.

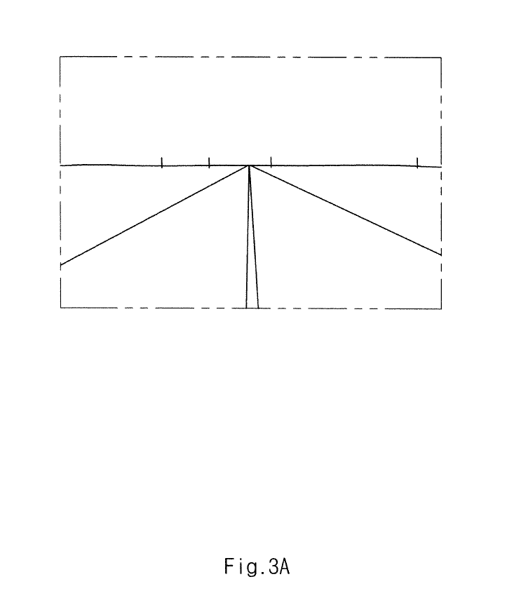

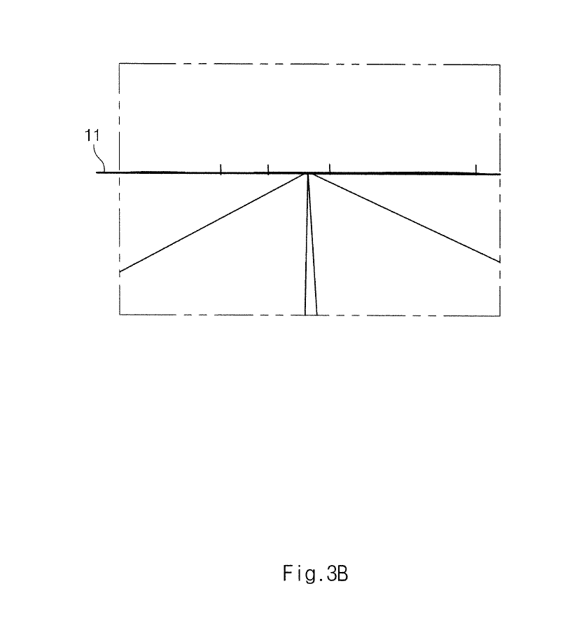

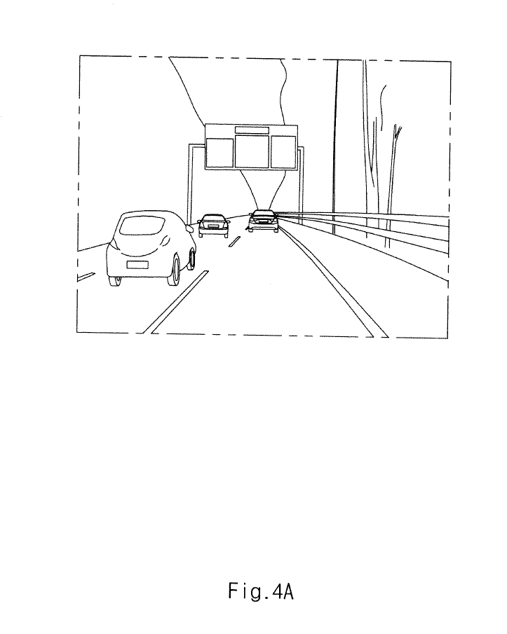

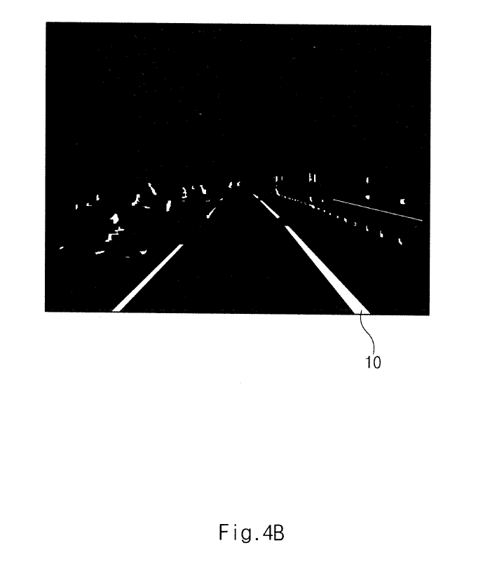

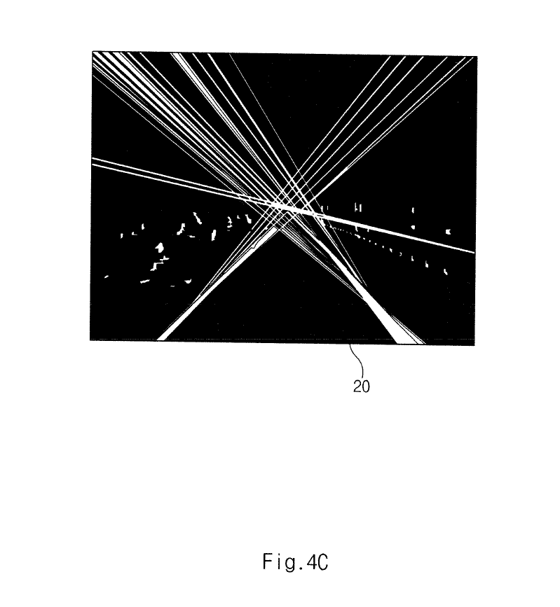

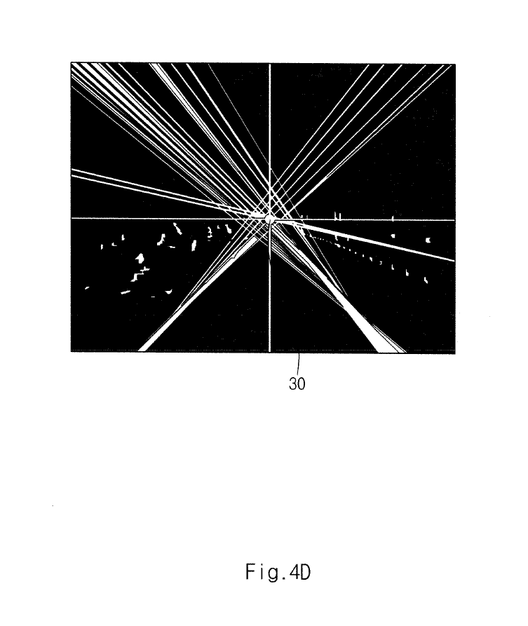

The data analyzer 220 extracts the horizon or the vanishing point from the image data received from the image acquisition unit 100. When the image data are received as illustrated in FIG. 3A, a horizon 11 is detected by a Hough transform method as illustrated in FIG. 3B. Further, when the image data are received as illustrated in FIG. 4A, an edge 10 is extracted from the image data as illustrated 4B. The line 20 is detected by the Hough transform method as illustrated in FIG. 4C, and then a vanishing point 30 which is an intersecting point of lines 20 may be extracted as illustrated in FIG. 4D.

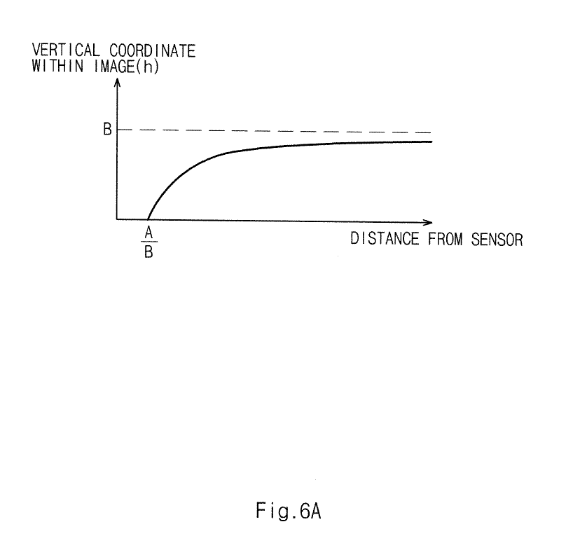

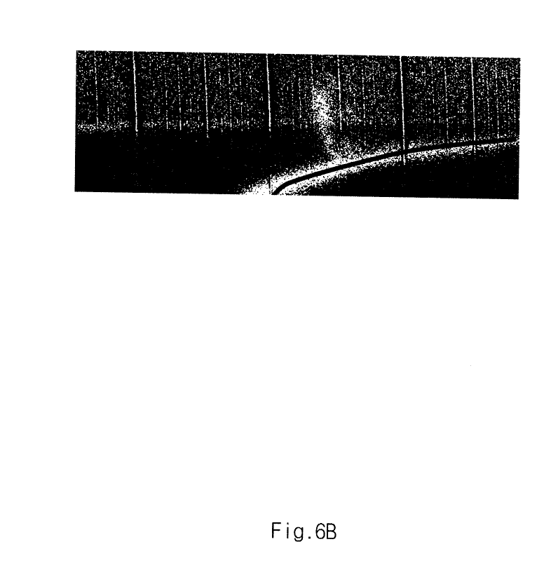

The road surface model applying unit 230 designs a road surface model of transforming an actual distance coordinate into an image coordinate in the image data and applying the horizon or the vanishing point. Therefore, the road surface model applying unit 230 applies the horizon or the vanishing point varying depending on a gradient of the road surface to more accurately define the road surface model and calculates distance information from the vehicle on the road surface in the image data using the road surface model. Referring to FIG. 6A, the road surface model reflects characteristics that a vertical coordinate of an obstacle within a short range is suddenly increased, and a vertical coordinate of an obstacle within a long range is smoothly increased.

A method for designing a road surface model of the road surface model applying 230 will be described in detail.

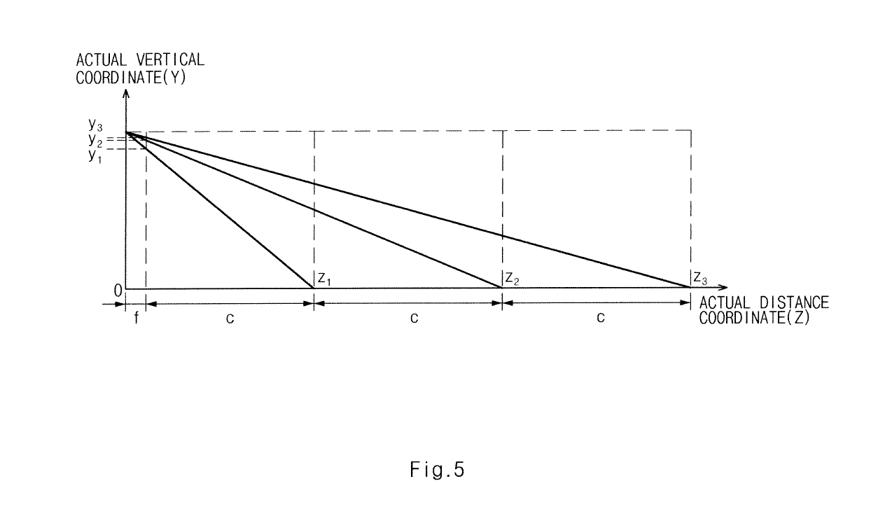

Hereinafter, the method for designing a road surface model will be described with reference to a graph of FIG. 5.

FIG. 5 is a graph illustrating a world coordinate which is the actual coordinate, in which Y represents an actual vertical coordinate axis, and Z represents an actual horizontal coordinate axis.

In FIG. 5, f represents a focus length of the camera which is the image acquisition unit 100: d represents a y direction coordinate which is a center of the camera; c represents a constant; z1, z2, and z3 represent a specific coordinate in a z direction; and y1, y2, and y3 represents a specific coordinate in a y direction.

It is assumed that point z1 on a road surface spaced by a horizontal distance f+c from a center of the image acquisition unit 100, that is, the camera, point z2 on a road surface spaced by a horizontal distance f+2c therefrom, and point z3 on a road surface spaced by f+3c therefrom are present.

The z1, z2, and z3 of the actual coordinate are each projected into the y1, y2, and y3 on the image data.

The y1 may be believed to be a y value in a case of a value of z=f in a function represented by the following

Equation 1 and may be represented by the following Equation 2.

$$\begin{matrix}y = - \frac{d}{f + c} z + d & [ Equation 1 ] \\ {y}_{1} = - \frac{d}{f + c} f + d \\ {y}_{2} = - \frac{d}{f + 2 c} f + d \\ {y}_{3} = - \frac{d}{f + 3 c} f + d & [ Equation 2 ]\end{matrix}$$

When z₁=f+c, r₂=f+2c, z₃=3c is applied to the above Equation 2, the y′ is represented by the following Equation 3.

$${y}^{′} = - \frac{d}{{z}^{′}} f + d \qquad [ Equation 3 ]$$

In the above Equation 3, when as in A=df and E=d, df is substituted into A and d is substituted into E, the road surface model may be designed as a y′ function as in the following Equation 4. Here, A and E are a constant.

$${y}^{′} = - \frac{A}{{z}^{′}} + E \qquad [ Equation 4 ]$$

That is, the function of Equation 4 becomes the road surface model.

The y-axis coordinates of the world coordinate are transformed into a vertical direction axis h in the image data. A transformation Equation thereof is represented by the following Equation 5.

h₁=y₁−(d−1)

h₂=y₂−(d−l)

h₃=y₃−(d−l) [Equation 5]

When the above Equation 5 is applied to the above Equation 4, the following Equation 6 may be derived.

$${h}^{′} = - \frac{A}{{z}^{′}} + E - ( d - l ) \qquad [ Equation 6 ]$$

Next, when B=E−(d−l) is applied to the above

Equation 6, the following Equation 7 is derived.

$${h}^{′} = - \frac{A}{{z}^{′}} + B \qquad [ Equation 7 ]$$

In the above Equation 7, B represents the vertical coordinate of the horizon in the image data. In this case, the vertical coordinate B of the horizon represents the coordinate of the ideal horizon on a flat road surface of which the gradient of the road surface is 0. The vertical coordinate B of the horizon is represented by a graph as illustrated in FIG. 6A.

FIG. 6A illustrates that the vertical coordinate value steeply rises in the early stage while being away from the camera which is the image acquisition unit 100 and has a smooth curve at a predetermined distance or more. That is, when the obstacle is close to the vehicle in the image data, the vertical value of the obstacle is largely shown but as the obstacle is far away from the own vehicle, a change in the vertical value of the obstacle is relatively small. FIG. 6B is a diagram illustrating results acquired by actually photographing the vertical direction position with a distance measuring sensor in the image data depending on the road surface model according to an exemplary embodiment of the present disclosure and has a substantially similar shape to the graph of FIG. 6A which is the graph depending on the road surface model.

That is, the road surface model of Equation 7 applies a size of the obstacle depending on perspective. In this case, several image data for each size are made by a pyramid method, and thus, each of the several image data is not subjected to the sliding window, and the road surface model of the above Equation 7 is applied and may derive the same effect as the image data pyramid method.

The above Equation 7 which is the road surface model as described above represents the road surface model on the flat road surface, that is, the ideal road surface. However, the actual road surface may not be flat but has a gradient. Therefore, the road surface model may be changed to which the gradient is applied. In this case, when the vehicle is driven on an uphill road, the actual horizon is calculated as a higher position than the horizon of the flat road surface, and when the vehicle is driven on a downhill road, the actual horizon is calculated as a lower position than the horizon of the flat road surface.

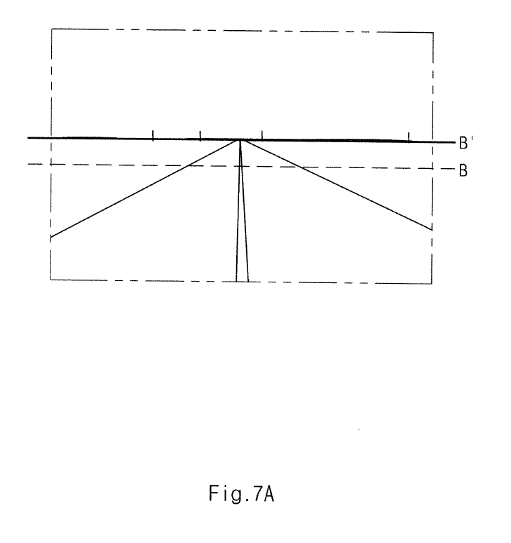

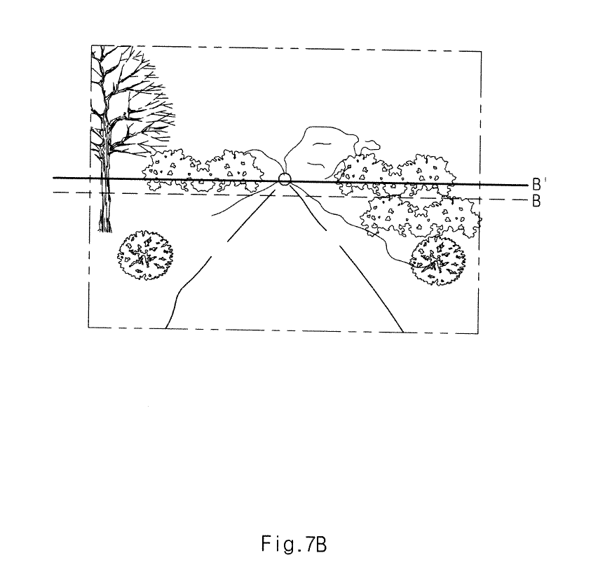

FIG. 7A is a diagram illustrating an actual horizon coordinate B′ calculated from the image data acquired according to an exemplary embodiment of the present disclosure and an ideal horizon coordinate B. That is, in the road surface model of the above Equation 7, B has an ideal horizon coordinate value on the flat road surface without a gradient, and the actual road surface has a gradient, and therefore, the actual horizon coordinate B′ may be higher and lower than the ideal horizon coordinate B. FIG. 7B is a diagram illustrating an actual vanishing point coordinate B′ calculated from the image data acquired according to an exemplary embodiment of the present disclosure and an ideal vanishing point coordinate B, and similar to the horizon, the vanishing point coordinate varies depending on the gradient, and therefore, the change in the horizon or the vanishing point depending on the gradient may be applied to the road surface model of the above Equation 7.

In the above Equation 7, when the horizon vertical coordinate on the flat road surface is B, and the actually measured horizon vertical coordinate is B′, the road surface model to which the gradient of the road surface is applied is defined by the following Equation 8.

$${h}^{′} = - \frac{{A}^{′}}{{z}^{′}} + {B}^{′} \qquad [ Equation 8 ]$$

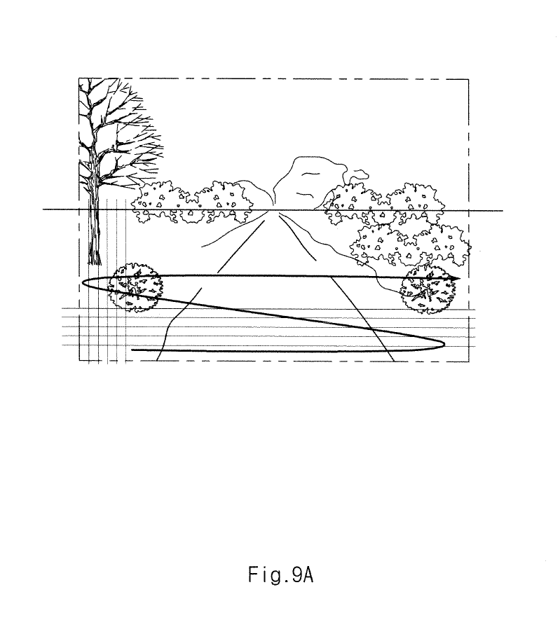

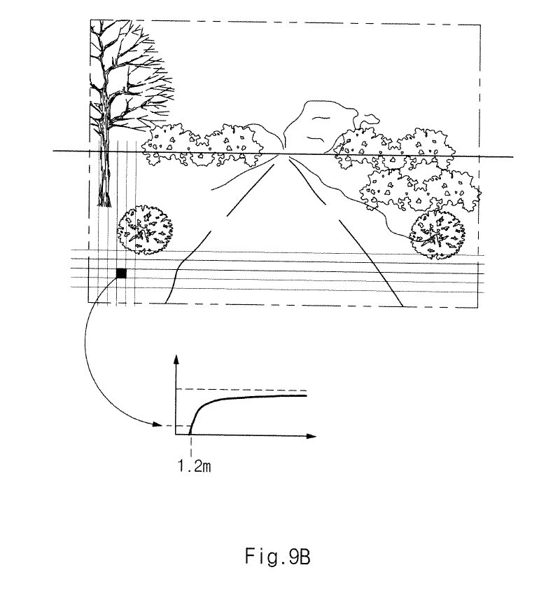

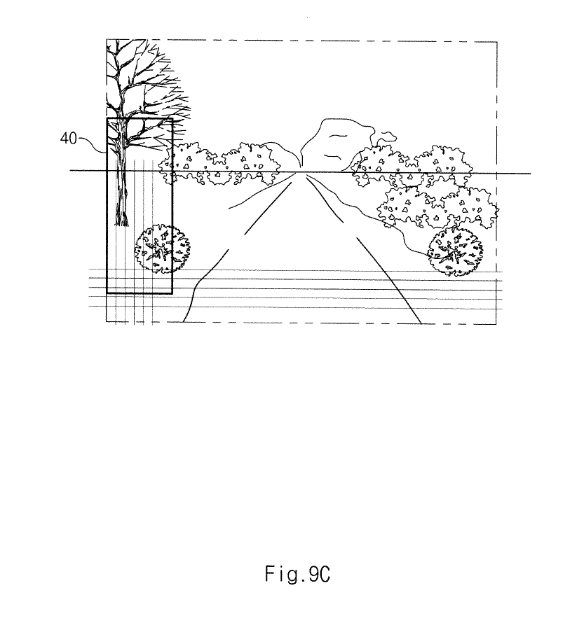

As illustrated in FIG. 9A, the obstacle tracker 240 scans each pixel in the image data to which the road surface model is applied and as illustrated in FIG. 9B, acquires the distance information of the corresponding pixel. Next, the obstacle tracker 240 determines window sizes for each distance information, and as illustrated in FIG. 9C, slides the window to detect the obstacle.

TABLE 1

| Distance | Height of | Width of |
|---|---|---|
| Information | Window (The Number | window (The |
| (m) | of Pixels) | number of pixels) |
| 1.2 | 143 | 59 |
| 1.3 | 140 | 57 |
| . . . | . . . | . . . |

Table 1 shows the size information of the obstacles determined as the obstacles for each distance, in which the information on the window size for scanning the obstacle is stored. The information on the window sizes for each distance of Table 1 is previously defined and stored. Therefore, the obstacle tracker 240 may refer to the Table 1 to determine the window size.

For example, at a distance of 1.2 m, a pedestrian has a height at which the number of pixels is 143 and a width at which the number of pixels is 59. Therefore, at the distance of 1.2 m, the window is determined with a height at which the number of pixels is 143 and a width at which the number of pixels is 59. The determined window is applied to determine and detect the obstacle included in the corresponding window as the pedestrian. The setting may be differently defined depending on experiment environment, camera characteristics, and the like.

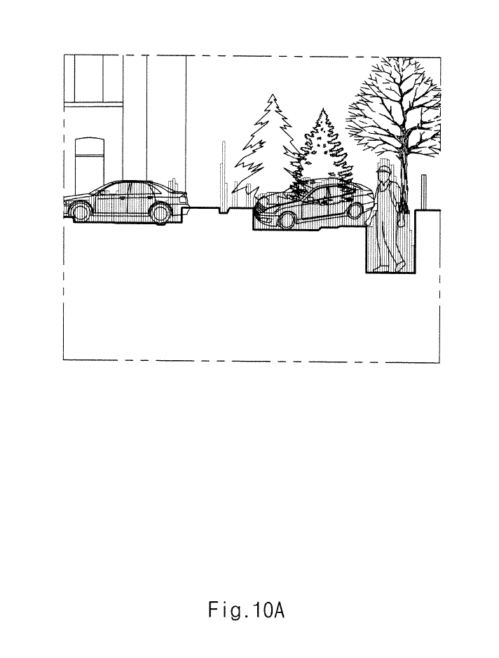

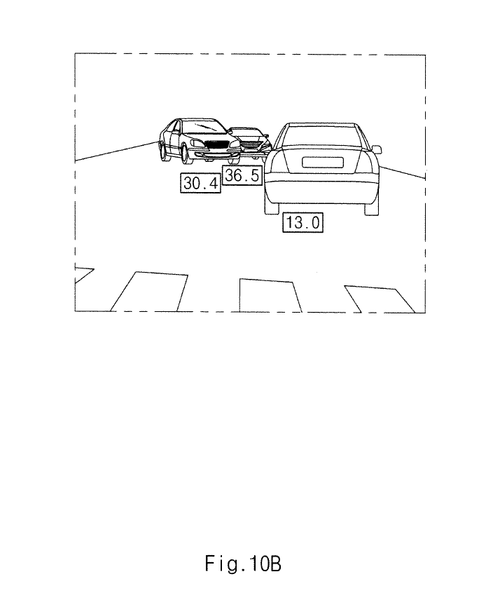

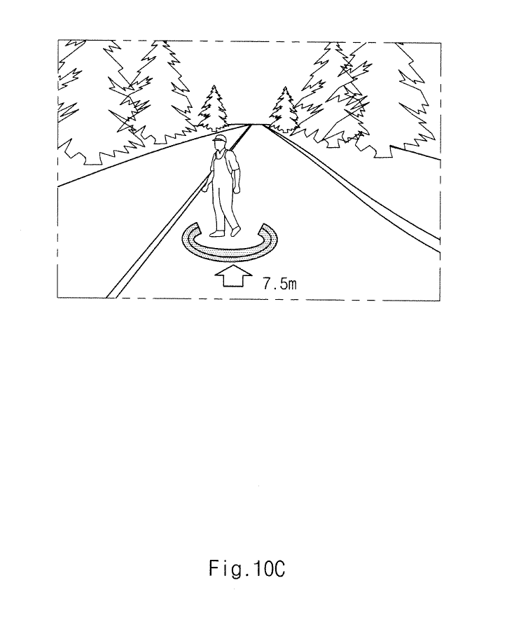

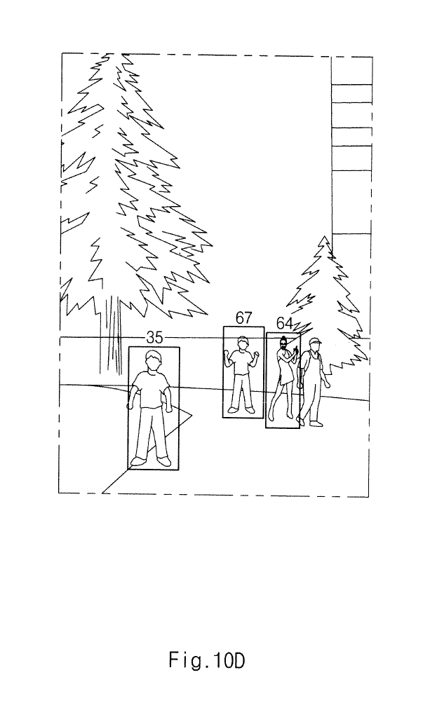

The display 300 displays the obstacle on the image data and displays a distance between the obstacle and the vehicle for a driver to recognize a distance from the obstacle. FIG. 10A illustrates an example which the distance from the obstacle is represented by a color. FIG. 10B illustrates an example in which the distance information is represented by a number box. FIG. 10C illustrates an example in which a pedestrian is recognized as an obstacle and which represents the distance between the own vehicle and the pedestrian as being represented by a number along with an arrow. FIG. 10D illustrates an example in which the pedestrian is represented by a square box and the distance information from the vehicle is represented on the square box.

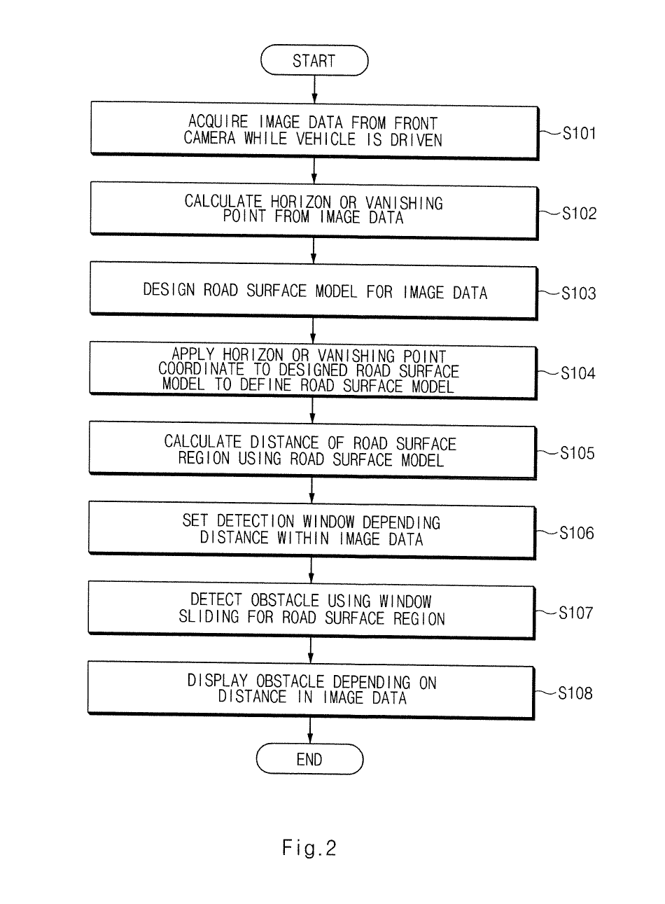

Hereinafter, the method for detecting an obstacle according to an exemplary embodiment of the present disclosure will be described in detail below with reference to FIG. 2.

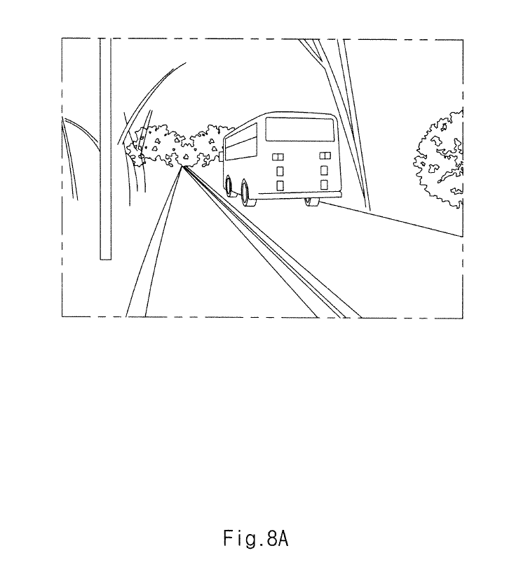

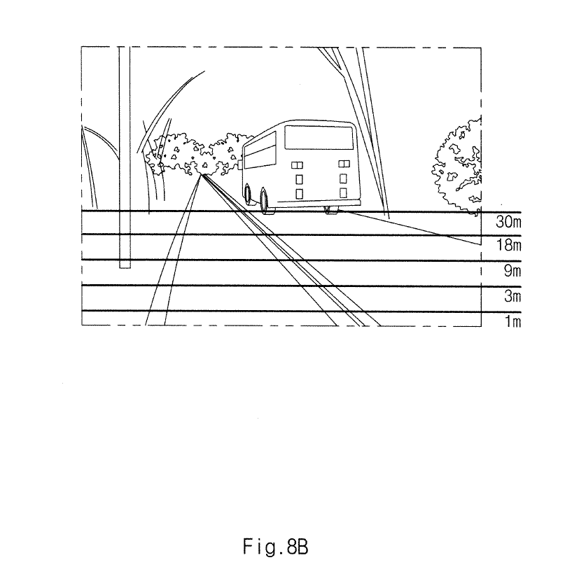

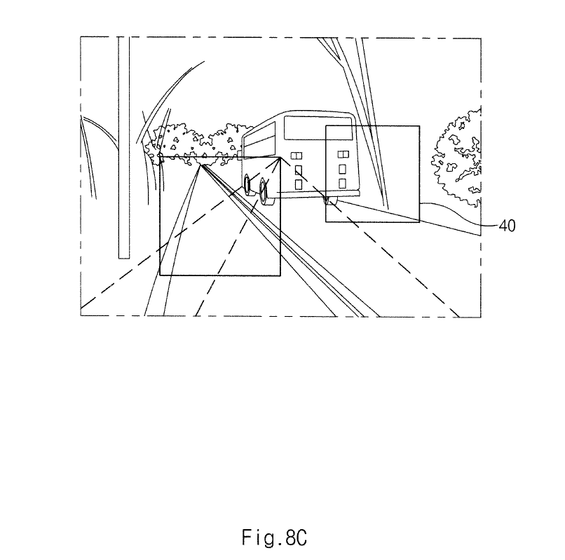

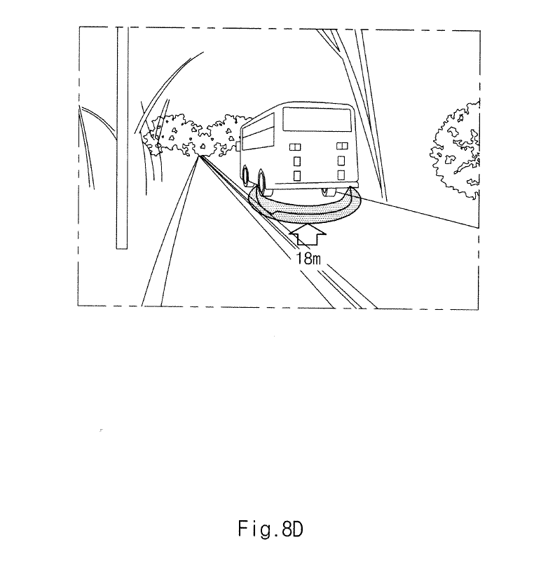

First, the image acquisition unit 100 acquires the image data for at least one of a front, a rear, and sides of a vehicle while the vehicle is driven, and provides the acquired image data to the obstacle detector 200 (S101). In this case, the acquired image data are illustrated in FIG. 8A.

Therefore, as illustrated in FIGS. 3A to 4D, the obstacle detector 200 calculates the horizon or vanishing point coordinate from the image data (S102).

The obstacle detector 200 designs the road surface model (Equation 7) for the image data (S103) and applies the horizon or vanishing coordinate B′ to the designed road surface model to define the road surface mode (S104).

The obstacle detector 200 uses the defined road surface model (Equation 8) to calculate the distance of the road surface region in the image data (S105). In this case, FIG. 8B is an exemplified diagram illustrating the distance information from the vehicle of the road surface region in the image data.

Next, the obstacle detector 200 sets a detection window depending on the distance information in the image data by referring to Table 1 (S106) and performs the sliding window on the road surface region of the image data to detect the obstacle (S107). FIG. 8C is a diagram illustrating an example in which the window is set in the image data according to the exemplary embodiment of the present disclosure to detect the obstacle.

As illustrated in FIG. 8D, the display 300 displays the obstacle depending on the distance in the image data along with the distance information (S108). In this case, FIGS. 10A to 10D are diagrams illustrating another example in which the obstacle detected by the method for detecting an obstacle according to an exemplary embodiment of the present disclosure is displayed on the image data depending on the distance information.

As described above, the exemplary embodiment of the present disclosure applies the road surface model without generating an image pyramid and thus may not need to generate several unnecessary images and may detect the obstacle having various sizes by performing a sliding window without performing each sliding window on several unnecessary various images. Further, the sliding window is performed only on the road surface region by performing the sliding window on the road surface region excepting the unnecessary region (background), not on the entire region of the image data, such that, the obstacle processing speed may be remarkably rapid and accurate.

Further, the exemplary embodiment of the present disclosure may increase the obstacle detection speed and accuracy only by the change in algorithm without adding a physical component.

Further, the exemplary embodiment of the present disclosure is not limited to detecting an obstacle and is applied to other systems, such as an autonomous emergency braking (AEB) system, a forward collision warnings (FCW) system, and a spot light to additionally provide various services such as detecting a collision risk with the obstacle and operating an active high beam depending on a position of an obstacle.

As described above, according to the exemplary embodiments of the present disclosure, it is possible to improve the detection speed and accuracy of the obstacle to rapidly and accurately provide the distance information from the obstacle to a driver, thereby supporting the safe driving of the driver.

The exemplary embodiments of the present disclosure described above have been provided for illustrative purposes. Therefore, those skilled in the art will appreciate that various modifications, alterations, substitutions, and additions are possible without departing from the scope and spirit of the invention as being disclosed in the accompanying claims and such modifications, alterations, substitutions, and additions fall within the scope of the present disclosure.

What is claimed is:

1. A system for detecting an obstacle, comprising:
an image acquisition unit configured to acquire image data around a camera; and
an obstacle detector configured to apply a road surface model using a horizon or a vanishing point to the image data and perform a sliding window on a road surface region to detect the obstacle.

2. The system according to claim 1, further comprising:
a display configured to display the obstacle on the image data along with distance information.

3. The system according to claim 1, wherein the obstacle detector includes:
a storage configured to store the image data;
a data analyzer configured to detect the horizon or the vanishing point in the image data;
a road surface model applying unit configured to use the horizon or the vanishing point in the image data to set and apply the road surface model; and
an obstacle tracker configured to perform the sliding window on the road surface region of the image data to which the road surface model is applied to track the obstacle.

4. The system according to claim 3, wherein the road surface model applying unit transforms an actual distance coordinate into an image coordinate of the image data and sets the road surface model to which a horizon or vanishing point coordinate is applied.

5. The system according to claim 3, wherein the road surface model applying unit sets the road surface model so that in the image data, a vertical coordinate of the obstacle within a short range is suddenly increased and a vertical coordinate of the obstacle within a long range is smoothly increased.

6. The system according to claim 3, wherein the road surface model applying unit applies the road surface model to the image data and calculates distance information from a vehicle of the road surface region.

7. The system according to claim 3, wherein the obstacle tracker performs scanning on each pixel of the image data, acquires distance information of the each pixel to determine window sizes for each distance, and performs the sliding window to detect the obstacle.

8. A method for detecting an obstacle, comprising steps of:
acquiring image data outside a vehicle while the vehicle is driven;
designing and applying a road surface model from the image data; and
performing a sliding window on a road surface below a horizon or a vanishing point in the image data to which the road surface model is applied to detect the obstacle.

9. The method according to claim 8, further comprising a step of:
displaying the obstacle on the image data and displaying distance information between the vehicle and the obstacle in the image data.

10. The method according to claim 9, wherein in the step of displaying the distance information between the obstacle and the vehicle, the distance information on each obstacle is represented by a number.

11. The method according to claim 10, wherein the step of designing and applying the road surface model includes steps of:
calculating a horizon or vanishing point coordinate from the image data;
designing the road surface model for the image data;
applying the calculated horizon or vanishing point coordinate to the designed road surface model to define the road surface model; and
calculating a distance of a road surface region using the defined road surface model.

12. The method according to claim 11, wherein in the step of designing the road surface model, an actual distance coordinate is transformed into an image coordinate of the image data and the road surface model to which the horizon or vanishing point coordinate is applied is set.

13. The method according to claim 12, wherein the road surface model has characteristics in the image data in which a vertical coordinate of the obstacle within a short range is suddenly increased and a vertical coordinate of the obstacle within a long range is smoothly increased.

14. The method according to claim 8, wherein the step of performing the sliding window includes steps of:
scanning pixels within the image data to which the road surface model is applied;
acquiring distance information on the scanned pixels;
determining window sizes for each distance; and
applying the determined window sizes to perform the sliding window.

15. The method according to claim 14, wherein in the step of determining the window sizes for each distance, the window sizes are determined as the number of pixels.

16. A non-transitory computer-readable recording medium comprising executable instructions, execution of which causes a processor to perform the method according to claim 8.
